(19) United States
(12) Patent Application Publication
(10) Pub. No.: US 2018/0184252 A1
(43) Pub. Date: Jun. 28, 2018

(54) TECHNOLOGIES FOR DELIVERING CONTENT TO A MOBILE COMPUTE DEVICE

(71) Applicants: Yen Hsiang Chew, Georgetown (MY); Jose A. Avalos, Chandler, AZ (US); Ping Chuin Ooi, Geluger (MY)

(72) Inventors: Yen Hsiang Chew, Georgetown (MY); Jose A. Avalos, Chandler, AZ (US); Ping Chuin Ooi, Geluger (MY)

(21) Appl. No.: 15/388,501

(22) Filed: Dec. 22, 2016

(51) Int. Cl. H04W 4/02; H04W 4/18

(52) U.S. Cl. CPC H04W 4/026; H04W 4/18

(57) ABSTRACT

Technologies for delivering content to a mobile compute device includes a content management compute device. The content management compute device may be associated with a content object and configured to transmit content related to the content object to a mobile compute device. To do so, the content management compute device is configured to determine which content object a user of the mobile compute device is interested in based on which object the user is pointing the mobile compute device toward.

### BACKGROUND

Location-Based Services (LBS) are information and entertainment services accessible by mobile stations through a wireless network that make use of the geographical location of the mobile device. Conventionally, a beacon or a location based service (LBS) pushes contents into a smartphone when the smartphone is within a close proximity of the beacon or at a predefined LBS location. A beacon or LBS may have multiple contents available to push into a smartphone. For example, a beacon at a retail store isle may have contents for multiple products on a shelve, or a LBS in front of multiple digital signage may have contents for different advertisements. However, the geographical location of the mobile device alone may not be adequate to select the best available content to transmit to the smartphone, and pushing all available contents into the smartphone may provide too much information for a user of the smartphone to digest in a short period of time.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for delivery of content to a mobile compute device;

FIG. 2 is a simplified block diagram of at least one embodiment of a content management compute device of the system of FIG. 1;

FIG. 3 is a simplified block diagram of at least one embodiment of an environment that may be established by the mobile compute device of the system of FIG. 1;

FIG. 4 is a simplified block diagram of at least one embodiment of an environment that may be established by the content management compute device of FIGS. 1 and 2;

FIGS. 5-7 are a simplified flow diagram of at least one embodiment of a method for delivering content to the mobile compute device that may be executed by the content management compute device of FIGS. 1, 2, and 4;

FIGS. 8-9 are a simplified flow diagram of at least one embodiment of a method for receiving content that may be executed by the mobile compute device of FIGS. 1 and 3;

FIG. 10 is a plan view of a simplified diagram of at least one embodiment of an aisle of content having a number of different content objects located therein; and

FIG. 11 is an elevated view of a simplified diagram of at least one embodiment of a content shelf having a number of different content objects located thereon.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

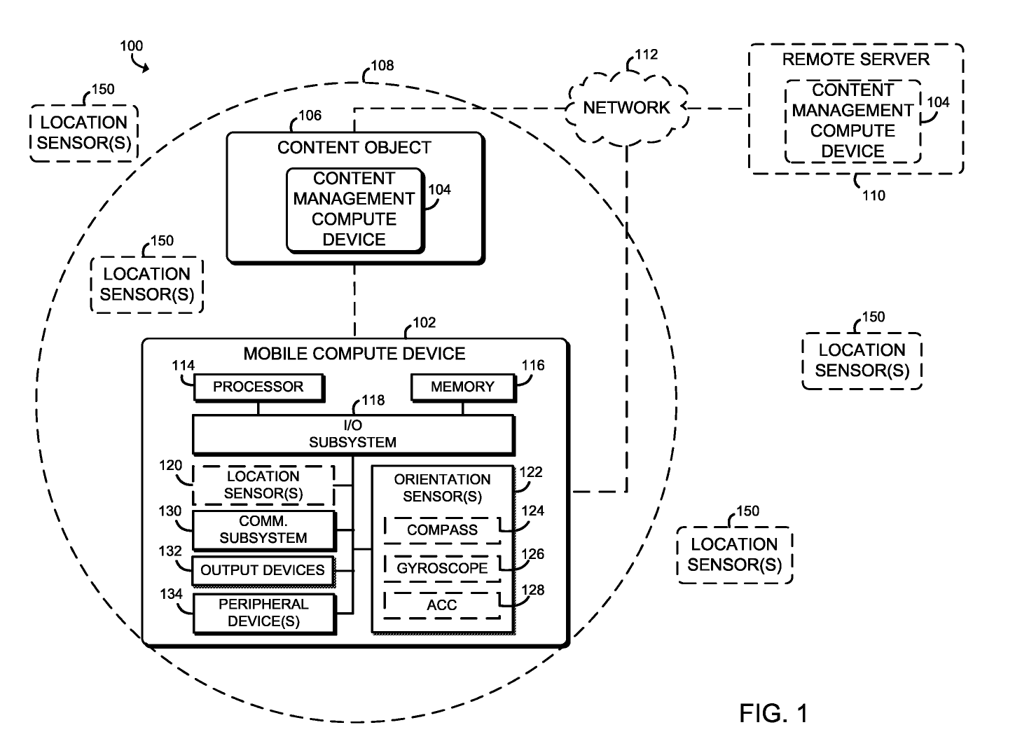

Referring now to FIG. 1, in an illustrative embodiment, a system 100 for delivering content to a mobile compute device 102 includes a content management compute device 104 configured to communicate with the mobile compute device 102 to deliver content thereto based on a location and/or an orientation of the mobile compute device 102. To do so, the content management compute device 104 determines whether the mobile compute device 102 is located within an active content area 108 of a content object 106 that is managed by the content management compute device 104. If so, the content management compute device 104 may request an authorization to transmit content (e.g., information, advertisements, coupons, etc.) related to the content object 106 to the mobile compute device 102. Additionally or alternatively, the user of the mobile compute device 102 may actively request the content related to the content object 106 from the content management compute device 104. For example, in some embodiments, the user may shake or move the mobile compute device 102 in a reference manner to indicate a desire to receive the content related to the content object 106. In response to the user's request or authorization, the content management compute device 104 determines which content object 106 the user is interested in based on the location and the orientation of the mobile compute device 102 and transmits available content related to the content object 106 to the mobile compute device 102 as discussed in more detail below.

For example, the user of the mobile compute device 102 may enter a store and desire to know more information about a specific product displayed on a shelf. To select a particular product, the user may point to the product with the user's mobile compute device 102. In some embodiments, the user may point to the product with the user's mobile compute device 102 and move or shake the mobile compute device 102 to indicate a desire to receive content about the selected product. Alternatively, in other embodiments, the user may point to the product with the user's mobile compute device 102 and make a selection on a user interaction of the mobile compute device 102 (e.g., touching a soft button of a touchscreen interface) to indicate a desire to receive content related to the selected product. In response to the user's request, the content management compute device 104 determines the particular product the user is interested in based on which product (i.e., which content object 106) the user is presenting pointing to with the mobile compute device 102. Once the content management compute device 104 determines the selected product, the content management compute device 104 transmits available information about the selected product, such as, a coupon, a brand, a website, a brochure, a price, available colors, and/or available sizes of the product. Of course, other or additional information related to the product may be provided to the user's mobile compute device 102 in other embodiments. Additionally or alternatively, the content management compute device 104 may proactively transmit information about a product that is displayed near the user by determining the location of the user's mobile compute device 102.

The content object 106 may be embodied as any type of product, advertisement, information notice, or other object, device, or structure for which additional information may be available to a user. For example, the content object 106 may be embodied as product for sell, advertisements of products, notices, or other objects. In some embodiments, as shown in FIG. 1, a content management compute device 104 may be associated with or incorporated in the content object. In such embodiments, the content object 106 may be considered as a “smart” content object, such as a smart advertisement or smart product. In other embodiments, the content management compute device 104 may be remote from the content object 106 but configured to manage user interactions with the content object 106 to deliver content related to the content object 106 to the user's mobile compute device 102. For example, as shown in FIG. 1, the content management compute device 104 may be located in a remote server 110 and communicate with the mobile compute device 102 via a network 112. In such embodiments, the content object 106 may be considered as a “dumb” content object, such as a product itself or a traditional advertisement.

As discussed above, the content management compute device 104 is configured to transmit the content related to the content object 106 to the mobile compute device 102 located within the active content area 108. To do so, the content management compute device 104 determines whether the mobile compute device 102 is within the active content area 108 of the content object 106 based on the location of the mobile compute device 102. As discussed in detail below, in some embodiments, the content management compute device 104 may determine the location of the mobile compute device 102 based on location signals received from the mobile compute device 102 itself, such as Bluetooth or wireless communication signal. In other embodiments, the system 100 may include multiple location sensors 150 and the content management compute device 104 may determine the location of the mobile compute device 102 based on location data received from the location sensors 150. For example, the content management compute device 104 may determine the location of the mobile compute device 102 using trilateration or triangulation, such as WiFi triangulation or trilateration, based on the location data produced by the location sensors 150. The location sensors 150 may be embodied as any type of sensor or device capable of producing sensor data indicative of a location of the mobile compute device 102 or from which the location may be determined. For example, in some embodiments, the location sensors 150 may be embodied as receiving circuits and/or antennas.

The mobile compute device 102 may be embodied as any type of computation or compute device capable of performing the functions described herein, including, without limitation, a smartphone, a tablet computer, a laptop computer, a notebook, desktop computer, a netbook, an Ultrabook™, a smart device, a personal digital assistant, a wearable compute device, a mobile Internet device, and/or other compute device. As shown in FIG. 1, the illustrative mobile compute device 102 includes a processor 114, a memory 116, an input/output (“I/O”) subsystem 118, one or more location sensors 120, one or more orientation sensors 122, a communication subsystem 130, one or more output devices 132, and one or more peripheral devices 134. Of course, the mobile compute device 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 116, or portions thereof, may be incorporated in the processor 114 in some embodiments.

The processor 114 may be embodied as any type of processor capable of performing the functions described herein. For example, the processor 114 may be embodied as a single or multi-core processor(s), digital signal processor, microcontroller, or other processor or processing/controlling circuit. Similarly, the memory 116 may be embodied as any type of volatile or non-volatile memory or data storage capable of performing the functions described herein. In operation, the memory 116 may store various data and software used during operation of the mobile compute device 102 such as operating systems, applications, programs, libraries, and drivers. The memory 116 is communicatively coupled to the processor 114 via the I/O subsystem 118, which may be embodied as circuitry and/or components to facilitate input/output operations with the processor 114, the memory 116, and other components of the mobile compute device 102. For example, the I/O subsystem 118 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 118 may form a portion of a system-on-a-chip (SoC) and be incorporated, along with the processor 114, the memory 116, and other components of the mobile compute device 102, on a single integrated circuit chip.

In some embodiments, the mobile compute device 102 includes one or more location sensors 120. The location sensor(s) 120 may be embodied as any type of sensor, circuit, or component capable of determining the present location of the mobile compute device 102 or capable of producing sensor data from which the location may be determined. For example, the location sensor(s) 120 may be embodied as a Global Positioning Sensor (GPS) circuit configured to determine a location of the mobile compute device 102 or as another communication circuit capable of receiving signals from which the mobile compute device 102 can determine its present location.

Of course, the mobile compute device 102 may utilize other techniques to determine its present location. For example, other sensors, such as inertial and environmental sensors may also be used to present location information. Additionally, in some embodiments, one or more wireless communication circuits may also provide location information. For example, a triangulation operation can be implemented using communications between the mobile compute device 102 and a wireless network such as a WLAN or WWANs, e.g., a given cellular system in accordance with a 3G or 4G/LTE communication protocol. Still further, location information can also be determined via identification of wireless access points in a local area network with the mobile compute device 102, which identifications can then be used to then determine the location of the mobile compute device 102. Of course, the location of the mobile compute device 102 can be determined in other manners in yet further embodiments.

The orientation sensors 122 may be embodied as any type of sensor, circuit, or component capable of generating sensor data indicative of the orientation (e.g., three-dimensional orientation or position) of the mobile compute device 102. For example, the orientation sensor(s) 122 may be embodied as, or otherwise include, a compass 124, a gyroscope 126, and/or an accelerometer (ACC) 128. As discussed in detail below, the orientation of the mobile compute device 102 is used to determine which content object 106 is being selected by the user based on the direction at which the mobile compute device 102 is pointing. Additionally, the orientation signals may also be used to detect a content request action of the user of the mobile compute device 102. As discussed in more detail below, the content request action may be embodied as any action, gesture, touch, sound, or visual indication that the user of the mobile compute device 102 may employ in order to request for content to the content management compute device 104. For example, in the illustrative embodiment, the user of the mobile compute device 102 may shake the mobile compute device 102 to request content.

The communication subsystem 130 may be embodied as any type of communication circuit, device, or collection thereof, capable of enabling communications with the content management compute device 104. To do so, the communication subsystem 130 may be configured to use any one or more communication technologies (e.g., wireless or wired communications) and associated protocols (e.g., Ethernet, Bluetooth®, Wi-Fi®, WiMAX, LTE, 5G, etc.) to effect such communication. In embodied in which the content management compute device 104 is located on, or embodied as, the remote server 110, the mobile compute device 102 may communicate with the remote server over the network 112 via the communication subsystem 130. Additionally, it should be appreciated that in those embodiments in which the system 100 includes the location sensors 150, the location of the mobile compute device 102 may be determined by the content management compute device 104 based on signals, such as WiFI or BLUETOOTH® signals, transmitted by the communication subsystem 130.

The output devices 132 may be embodied as any type of device, circuit, or component capable of generating an output on the mobile compute device 102. For example, the output devices 132 may include a display, a speaker or other audio output device, one or more visible lights and/or IR LEDS, and/or other output devices. In some embodiments, the output devices 132 may be embodied as, or otherwise include, a display to provide information to the user of the mobile compute device 102. In such embodiments, the display may be embodied as any type of display capable of displaying digital information such as a liquid crystal display (LCD), a light emitting diode (LED) display, an organic light emitting diode (OLED) display, a plasma display, a cathode ray tube (CRT), or other type of display device. In some embodiments, the display may include a touch screen to allow user interaction with the mobile compute device 102. The mobile compute device 102 may also include any number of additional input/output devices, interface devices, and/or other peripheral devices 134. For example, in some embodiments, the peripheral devices 134 may include a touch screen, graphics circuitry, keyboard, mouse, speaker system, network interface, and/or other input/output devices, interface devices, and/or peripheral devices.

As discussed above, the content management compute device 104 may be located in, or otherwise embodied as, the remote server 110 in some embodiments. The remote server 110 may be embodied as any type of server or compute device capable of performing the functions described herein. The remote server 110 includes components typically found in a server compute device, such as a processor, memory, and communication circuit, the description of which is similar to the corresponding components of the mobile compute device 102 and is not repeated herein for clarity of the description.

The content management compute device 104 communicates with the mobile compute device 102 and/or the content object 106 over the network 112 as discussed above. The network 112 may be embodied as any type of communication network capable of facilitating communication between the remote server 110 and the mobile compute device 102 and/or content object 106. As such, the network 112 may include one or more networks, routers, switches, gateways, computers, and/or other intervening devices. For example, the network 112 may be embodied as or otherwise include one or more local or wide area networks, cellular networks, publicly available global networks (e.g., the Internet), an ad hoc network, a short-range communication network or link, or any combination thereof.

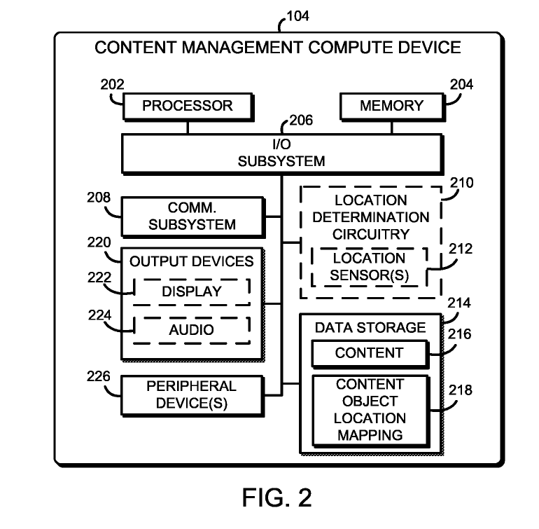

Referring now to FIG. 2, the content management compute device 104 may embodied as any type of compute device capable of delivering content related to a selected content object 106 to a user's mobile compute device 102 and performing the additional functions described herein. In some embodiments, the content management compute device 104 may be embodied as an integrated or specialized compute device sized to be attached or coupled to the corresponding content object. For example, the content management compute device 104 may be embodied as a System-on-a-Chip (SoC), and Application Specific Integrated Circuit (ASIC), or other integrated, miniaturized system. Of course, in other embodiments, the content management compute device 104 may be embodied as any type of compute device, such as a computer, server, tablet computer, laptop computer, and/or other computation device.

The illustrative content management compute device 104 includes a processor 202, a memory 204, an input/output (I/O) subsystem 206, a communication subsystem 208, an output devices 220, one or more peripheral device 226, and a data storage 214. The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the content management compute device 104 such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the content management compute device 104. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 202, the memory 204, and other components of the content management compute device 104, on a single integrated circuit chip.

The communication subsystem 208 may be embodied as any type of communication circuit, device, or collection thereof, capable of enabling communications between the content management compute device 104 and the mobile compute device 102 located within the active content area 108. To do so, the communication subsystem 208 may be configured to use any one or more communication technologies (e.g., wireless or wired communications) and associated protocols (e.g., Ethernet, Bluetooth®, Wi-Fi®, WiMAX, LTE, 4G, 5G, etc.) to effect such communication. In some embodiments, as discussed above, the content management compute device 104 may be located in, or otherwise embodied as, the remote server 110 and communicate with the mobile compute device 102 over the network 112.

As discussed above, the content management compute device 104 is configured to determine the location and orientation of the mobile compute device 102 based on the location information and orientation information received from the mobile compute device 102. To do so, in some embodiments, the content management compute device 104 includes a location determination circuitry 210, which may determine the location of the mobile compute device 102 based on communication signals received therefrom. The location determination circuitry 210 may be embodied as, for example, a Bluetooth commutation device. In such embodiments, the location determination circuitry 210 may transmit an interrogation signal to the mobile compute device 102 and wait for a response therefrom using, for example, a Bluetooth communication protocol or other protocol. Of course, it should be appreciated that the location determination circuitry 210 may be embodied as the communication subsystem 208 or form a portion thereof in some embodiments. Additionally or alternatively, in some embodiments, the location determination circuitry 210 may include its own location sensors 212 such as, for example, a WiFi sensor, to facilitate the triangulation or trilateration of the location of the mobile compute device 102. In such embodiments, even though the mobile compute device 102 may not actively transmit its location to the content management compute device 104, the content management compute device 104 may determine the location of the mobile compute device 102 by scanning for communication signals, such as Bluetooth, GPS, or WiFi signals, of the mobile compute device 102 using its own location sensors 212. Of course, in other embodiments, other technologies and methodologies may be used to determine the location of the mobile compute device relative to the content object 106.

The output devices 220 may be embodied as any type of device, circuit, or component capable of generating an output on the content management compute device 104. For example, the output devices 220 may include a display 222, an audio 224, one or more visible lights and/or IR LEDS (not shown), and/or other output devices. In some embodiments, the output devices 220 may be embodied as, or otherwise, include a display 222 to provide information to the user of the mobile compute device 102. The display 222 may be embodied as any type of display capable of displaying digital information such as a liquid crystal display (LCD), a light emitting diode (LED) display, an organic light emitting diode (OLED) display, a plasma display, a cathode ray tube (CRT), or other type of display device. In some embodiments, the display 222 may include a touchscreen to allow user interaction with the mobile compute device 102. The content management compute device 104 may also include any number of additional input/output devices, interface devices, and/or other peripheral devices 226. For example, in some embodiments, the peripheral devices 226 may include a touchscreen, graphics circuitry, keyboard, mouse, speaker system, network interface, and/or other input/output devices, interface devices, and/or peripheral devices.

The data storage 214 may be embodied as any type of device or devices configured for short-term or long-term storage of data such as, for example, memory devices and circuits, memory cards, hard disk drives, solid-state drives, or other data storage devices. In the illustrative embodiment, the content management compute device 104 may be configured to store content 216, content object location mapping 218, and other data in the data storage 214. The content 216 stored in the data storage 214 may be embodied as any type of content, such as information, advertisements, coupons, notices, and/or other data, related to a particular content object 106 and is delivered to the mobile compute device 102 as discussed herein. The content object location mapping 218 may be embodied as any type of mapping that provides an indication of the location of each content object 106 of the area of interest (e.g., as store) such that the content management compute device 104 may determine which content to retrieve based on a pointing vector of the mobile compute device 102 as discussed below.

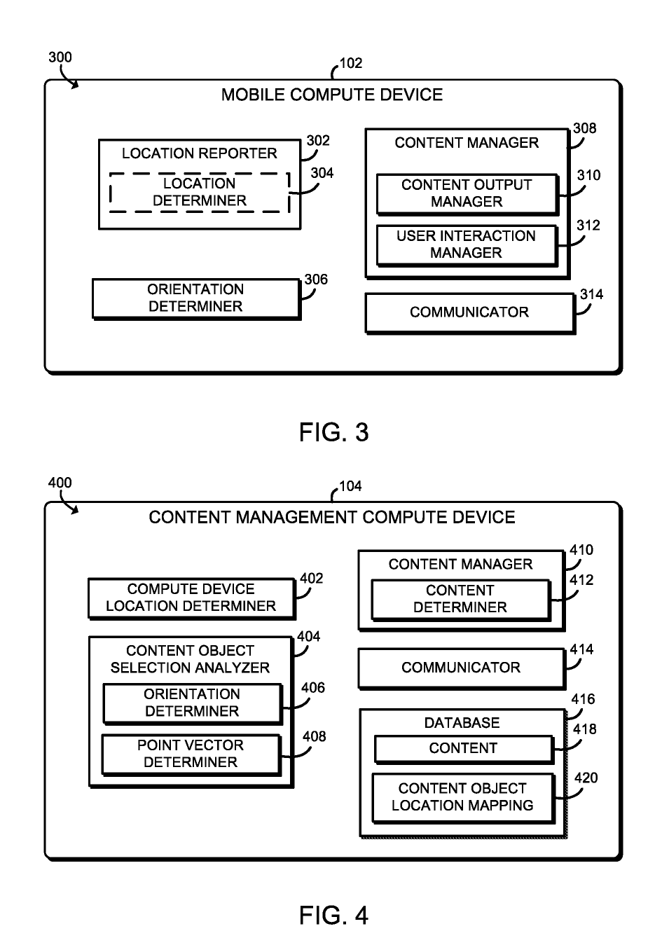

Referring now to FIG. 3, in use, the mobile compute device 102 establishes an environment 300. The illustrative environment 300 includes a location reporter 302, an orientation determiner 306, a content manager 308, and a communicator 314. The various components of the environment 300 may be embodied as hardware, firmware, software, or a combination thereof. As such, in some embodiments, one or more of the components of the environment 300 may be embodied as circuitry or collection of electrical devices (e.g., a location reporter circuit 302, an orientation determiner circuit 306, a content manager circuit 308, and a communicator circuit 314, etc.). It should be appreciated that, in such embodiments, one or more of the location reporter circuit 302, the orientation determiner circuit 306, the content manager circuit 308, and/or the communicator circuit 314 may form a portion of one or more of the processor 114, the I/O subsystem 118, the communication subsystem 130, and/or other components of the mobile compute device 102. Additionally, in some embodiments, one or more of the illustrative components of the environment 300 may form a portion of another component and/or one or more of the illustrative components may be independent of one another.

The location reporter 302 is configured to transmit signals to the content management compute device 104 (or the location sensors 150) indicative of the location of the mobile compute device 102 or from which the location may be determined. In embodiments in which the mobile compute device 102 determines its own location, the location reporter 302 may include a location determiner 304. The location determine 304 is configured to determine the location of the mobile compute device 102 based on signals received by the mobile compute device 102 (e.g., based on GPS signals). The location reporter 302 is configured to transmit the location information of the mobile compute device 102 to the content management compute device 104. The location information may be location signals received from the one or more location sensors 120 or the location of the mobile compute device 102 determined by the location determiner 304. It should be appreciated that the location reporter 302 may transmit the location information that includes either location signals from which the content management compute device 104 can determine the location of the mobile compute device 102 or the location determined by the location determiner 304 based on the location signals received from the one or more location sensors 120 of the mobile compute device 102. Additionally, in some embodiments, the location reporter 302 may proactively transmit the location signals, such as GPS, WiFi, or BLUETOOTH® signals, to the content management compute device 104. In other embodiments, the location reporter 302 may transmit the location information of the mobile compute device 102 in response to a request from the content management compute device 104.

The orientation determiner 306 is configured to determine the orientation of the mobile compute device 102 based on the orientation data received from the orientation sensors 122. In some embodiments, the orientation determiner 306 may be configured to transmit unprocessed orientation signals generated by the one or more orientation sensors 122 to the content managements compute device 104, which can be used to determine the orientation of the mobile compute device 102. In other embodiments, the orientation determiner 306 may initially process the raw orientation signals to generate an initial orientation information, such as a degree angle, and transmit the initial orientation information to the content management compute device 104.

The content manager 308 is configured to manage the acquisition and presentation of content on the mobile compute device 102. To do so, the content manager 308 includes a content output manager 310 and a user interaction manager 312. In the illustrative embodiment, the content manager 308 may determine a user's desire to receive content based on an input received from the user or a content request action performed by the user on the mobile compute device 102 (e.g., by shaking the device 102). If the content manager 308 determines that the user desires to receive content of a content object 106, the content manager 308 communicates that request to the content management compute device 104 via the communicator 314. After the content manager 308 receives the content from the content management compute device 104, the content output manager 310 outputs the received content (e.g., visual and/or audio contents) on the mobile compute device 102 via one or more of the output devices 132. Further, the user interaction manager 312 is configured to detect whether the user is interacting with the content presented on the mobile compute device. For example, in some embodiments, the presented content may be embodied as interactive content that allows the user to select different options, request additional content, or otherwise interact with the presented content. In response to user interaction with the content, the user interaction manager 312 may communicate with the content management compute device 104, via the communicator 314, to transmit the user's interactions and/or requests.

Referring now to FIG. 4, in use, each content management compute device 104 may establish an environment 400. The illustrative environment 400 includes a compute device location determiner 402, a content object selection analyzer 404, a content manager 410, a communicator 414, and a database 416. The various components of the environment 400 may be embodied as hardware, firmware, software, or a combination thereof. As such, in some embodiments, one or more of the components of the environment 400 may be embodied as circuitry or collection of electrical devices (e.g., a compute device location determiner circuit 402, a content object selection analyzer circuit 404, a content manager circuit 410, a communicator circuit 414, etc.). It should be appreciated that, in such embodiments, one or more of the compute device location determiner circuit 402, the content object selection analyzer circuit 404, the content manager circuit 410, and/or the communicator circuit 414 may form a portion of one or more of the processor 202, the I/O subsystem 206, the communication subsystem 208, and/or other components of the content management compute device 104. Additionally, in some embodiments, one or more of the illustrative components of the environment 400 may form a portion of another component and/or one or more of the illustrative components may be independent of one another.

The compute device location determiner 402 is configured to determine a relative location of the mobile compute device 102. To do so, the compute device location determiner 402 determines the location of the mobile compute device 102 based on the location signals received from the location sensors 120 of the mobile compute device 102, location signals received from the location sensors 150, and/or location signals received from the location sensors 212 of the content management compute device 104. As discussed above, in some embodiments, the compute device location determiner 402 may receive the location of the mobile compute device 102 determined by the location determiner 304 of the mobile compute device 102 (e.g., based on GPS signals received by the mobile compute device 102). In other embodiments, the compute device location determiner 402 may determine the relative location of the mobile compute device based on raw locations signals (e.g., communication signals such as WiFi or BLUETOOTH® signals), which may be received from the mobile compute device 102 itself or form the location sensors 150, 212. Regardless, the determined location of the mobile compute device 102 is used to determine whether the mobile compute device 102 is within the active content area 108 and further to determine the relative location of the mobile compute device 102 to content objects 106. It should be appreciated that the content object location mapping 420 may be used to determine the relative location of the mobile compute device 102.

As illustratively shown in FIG. 4, the content object selection analyzer 404 includes an orientation determiner 406 and a point vector determiner 408. The content object selection analyzer 404 is configured to determine which content object 106 is presently being selected by the user of the mobile compute device 102 based on the orientation of the mobile compute device 102. To do so, the orientation determiner 406 is configured to determine the orientation of the mobile compute device 102, and the point vector determiner 408 is configured to determine a pointing vector of the mobile compute device 102 based on the determined orientation of the mobile compute device 102. In some embodiments, the point vector determiner 408 may determine the pointing vector only after the mobile compute device 102 has been stabilized over a reference threshold period time, e.g., after the user has pointed the mobile compute device 102 to the content object 106 more than 2 seconds. In the illustrative embodiment, the determined pointing vector corresponds with a longitudinal axis of the mobile compute device 102, but other axes of the mobile compute device 102 may be used in other embodiments. It should be appreciated that the determination of the pointing vector, along with the content object location mapping stored in the database 416, allows the content manager 410 to determine the particular content object 106 selected by the user.

The content manager 410 is configured to manage the delivery of the content 418 of the associated content object 106 to the mobile compute device 102. To do so, the content manager includes a content determiner 412 configured to determine or select the content to be delivered to the mobile compute device 102 based on the content object 106 selected by the user. In embodiments in which the content management compute device 104 is associated with or incorporated into a single content object 106 (e.g., a “smart” content object), all of the content managed by the content manager 410 may be associated with or related to that particular content object 106. However, multiple and different content may be available for a signal content object. In such embodiments, the content determiner 412 determines which content to retrieve and transmits the retrieved content to the mobile compute device 102 via the communicator 414. To do so, the content determiner 412 may use any suitable additional data to select the content to be retrieved such as, for example, the context data such as the time of day, the number of times the user has selected the content object 106, and/or other context data; user data received from the mobile compute device 102 such as user identification data, user preference data, and/or other user data; and/or other data available to the content management compute device 104. Alternatively, in embodiments in which the content management compute device 104 manages multiple content objects 106, the content determiner 412 may determine which content to retrieve based on the particular content object 106 selected by the user (i.e., the content determiner 412 selects the content associated with the selected content object 106). In some embodiments, the content determiner 412 may be configured to select default content should the content determiner 412 determine that no associated or specialized content is available for a particular content object 106.

The database 416 is configured to store various data of the content management compute device 104. In the illustrative embodiment, the database 416 includes a content 418 and a content object location mapping 420. As discussed above, the content 418 may include a single content for a single content object 106, multiple different content for a single content object 106, or multiple content for multiple content objects 106, depending on, for example, the location of the content management compute device 104. In some embodiments, the content 418 may further include one or more default content, which may be delivered to the mobile compute device 102 in the event that no specialized content exists for a particular content object 106. The content object location mapping 410 may be embodied as a relative mapping that indicates locations of each content object 106. As discussed above, the content object location mapping 410 may be used to determine which content object 106 is presently selected by the user of the mobile compute device 102 based on the location of the mobile compute device 102 and the determined pointing vector of the mobile compute device 102.

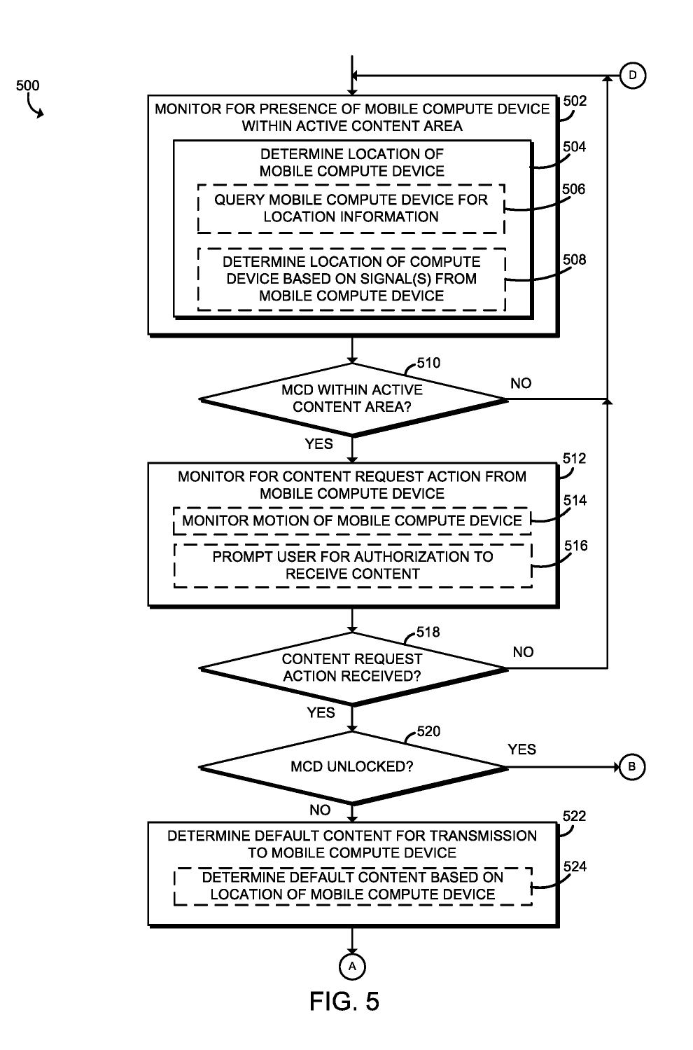

Referring now to FIGS. 5-9, in use, the content management compute device 104 may execute a method 500 for delivering content to the mobile compute device 102. The method 500 begins with block 502 in which the content management compute device 104 monitors for a presence of the mobile compute device 102 within its corresponding active content area 108. To do so, in the illustrative embodiment, the content management compute device 104 determines a location of the mobile compute device 102 in block 504. In some embodiments, the content management compute device 104 may determine the location of the mobile compute device 102 by querying the mobile compute device 102 for location information in block 506. For example, in those embodiments in which the mobile compute device 102 determines its own location (e.g., based on GPS signals), the content management compute device 104 may request the determined location in block 506. In other embodiments, the content management compute device 104 may determine the location of the mobile compute device 102 based on one or more signals (e.g., WiFi or BLUETOOTH® signals) received from the mobile compute device 102 and/or from the location sensors 150.

After determining the location of the mobile compute device 102 in block 502, the method 500 proceeds to block 510 in which the content management compute device 104 determines whether the mobile compute device 102 is within the active content area 108. For example, the content management compute device 104 may determine whether the mobile compute device 102 is within a reference threshold distance of the content management compute device 104 and/or of a managed content object 106. In embodiments in which the content management compute device 104 manages multiple content objects 106 (e.g., in those embodiments in which the content management compute device 104 forms a portion of the remote server 110), the content management compute device 104 may determine whether the mobile compute device 102 is within an active content area 108 of each managed content object 106.

If the content management compute device 104 determines that the mobile compute device 102 is not within an active content area 108 of a content object 106, the method 500 loops back to block 502 in which the content management compute device 104 continues to monitor for a presence of the mobile compute device 102 within an active content area 108. If, however, the content management compute device 104 determines that the mobile compute device 102 is within the active content area 108 of the content object 106, the method 500 advances to block 512. In block 512, the content management compute device 104 monitors for a content request action from the mobile compute device 102. As discussed above, in some embodiments, the content request action may be embodied as any action, gesture, touch, or motion of the mobile compute device 102. In such embodiments, the content management compute device 104 monitors the motion of the mobile compute device 102 in block 518. For example, as discussed above, the user of the mobile compute device 102 may shake the mobile compute device 102 to request content of the content object 106. In response, the content manager 308 of the mobile compute device 102 may transit the sensor data produced by the orientation sensors 122 in response to the user's shaking to the mobile compute device 102. Of course, the content manager 308 may transmit a more simplistic indication of the shaking or other content request motion action to the content management compute device 104 in other embodiments. In yet other embodiments, the content management compute device 104 may prompt the user of the mobile compute device 102 for an authorization to receive content in block 516. In such embodiments, the content manager 308 of the mobile compute device 102 may prompt the user for authorization to receive content and transmit the user's answer to the content management compute device 104.

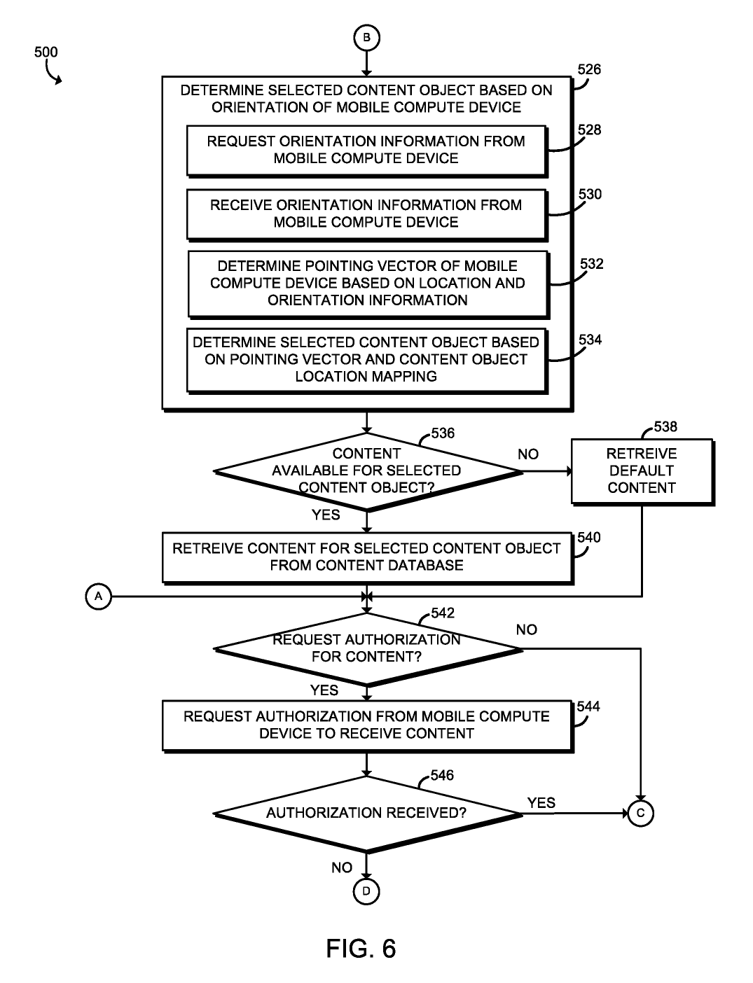

In block 518, the content management compute device 104 determines whether the content request action has been received from the mobile compute device 102. If not, the method 500 loops back to block 502 in which the content management compute device 104 continues to monitor for a presence of a mobile compute device 102 within the active content area 108. If, however, the content request action has been received, the method 500 advances to block 520. In block 520, the content management compute device 104 determines whether the mobile compute device 102 is unlocked. If the mobile compute device 102 is unlocked, additional information may be obtained from the mobile compute device 102 relative to when the mobile compute device 102 is locked. As such, if the content management compute device 104 determines that the mobile compute device 102 is locked, the method 500 advances to block 522 in which the content management compute device 104 determines a default content to be transmitted to the mobile compute device 102. In some embodiments, the content management compute device 104 may determine the default content based on the location of the mobile compute device 102 in block 524. After the content management compute device 104 determines the default content to be transmitted to the mobile compute device 102, the method 500 proceeds to block 542 of FIG. 6, in which the content management compute device 104 determines whether the content management compute device 104 requires an authorization from the mobile compute device 102 before transmitting the default content to the mobile compute device 102 as discussed in more detail below.

If, however, the content management compute device 104 determines that the mobile compute device 102 is unlocked in block 520, the method 500 advances to block 526 of FIG. 6. In block 526, the content management compute device 104 determines which content object 106 the user has selected based on the location and an orientation of the mobile compute device 102. To do so, the content management compute device 104 requests orientation information from the mobile compute device 102 in block 528 and receives the orientation information from the mobile compute device 102 in block 530. In block 532, the content management compute device 104 subsequently determines a pointing vector of the mobile compute device 102 based on the location of the mobile compute device 102 and the orientation information received in block 530. To do so, the content management compute device 104 may utilize any suitable methodology and technique to determine a pointing vector of the mobile compute device 102 based on the present location and orientation of the mobile compute device 102. Additionally, as discussed above, the determined pointing vector may correlate to a longitudinal axis of the mobile compute device 102 in some embodiments. After the content management compute device 104 has determined the pointing vector of the mobile compute device 102, the content management compute device 104 determines the selected content object 106 based on the pointing vector and the content object location mapping 420 in block 534. That is, by comparing the location and pointing vector of the mobile compute device 102 to the content object location mapping 420, the content management compute device 104 is able to determine which content object 106 the user is pointing toward with their mobile compute device 102.

After the content management compute device 104 has determined the selected content object 106 in block 526, the method 500 proceeds to block 536. In block 536, the content management compute device 104 determines whether any content is available for the selected content object 106. If not, the method 500 advances to block 538 in which the content management compute device 104 retrieves a default content for the selected content object 106 as discussed above in regard to block 522. The method 500 subsequently advances to block 542 discussed below. If, however, the content management compute device 104 determines that content is available for the selected content object 106, the method 500 proceeds to block 540 in which the content management compute device 104 retrieves the content for the selected content object 106 from the database 416.

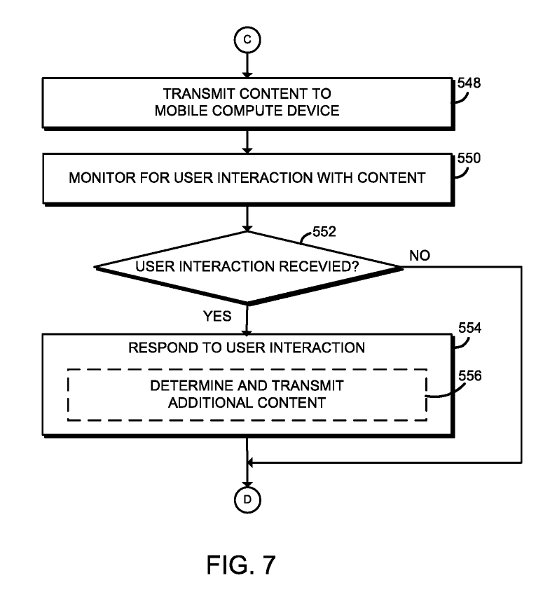

In block 542, the content management compute device 104 determines whether the mobile compute device 102 requires an authorization request before receiving the selected or default content. If not, the method 500 advances to block 548 of FIG. 7 in which the content management compute device 104 transmits the selected or default content to the mobile compute device 102. For example, the user of the mobile compute device 102 may have requested to receive the content from the content object 106 or have preauthorized to receive contents from content objects 106. Referring back to block 542, if the mobile compute device 102 determines that the mobile compute device 102 requires authorization before receiving the content, the method 500 advances to block 544 in which the content management compute device 104 requests authorization from the mobile compute device 102 to receive content of the content object 106. If the authorization is not received from mobile compute device 102, the method 500 loops back to block 502 of FIG. 5 in which the content management compute device 104 continues to monitor for the presence of a mobile compute device 102 within the active content area 108. For example, the user of the mobile compute device 102 may deny the authorization request from the content management compute device 104 or may not have responded to such request within a reference period of time.

If, however, the user's authorization is received in block 546, the method 500 advances to block 548 of FIG. 7. In block 548, the content management compute device 104 transmits the selected or default content to the mobile compute device 102. The content management compute device 104 subsequently monitors for any user interaction with the received content in block 550. If no indication of user interaction is received in block 552, the method 500 loops back to block 502 of FIG. 5 in which the content management compute device 104 continues to monitor for the presence of a mobile compute device 102 within the active content area 108. If, however, an indication of a user interaction is received in block 552, the method 500 advances to block 554 in which the content management compute device 104 responds to the user interaction. For example, in some embodiments, the content management compute device 104 may determine and transmit additional content in block 556. After responding to the user interaction, the method 500 loops back to block 502 of FIG. 5 in which the content management compute device 104 continues to monitor for the presence of a mobile compute device 102 within the active content area 108.

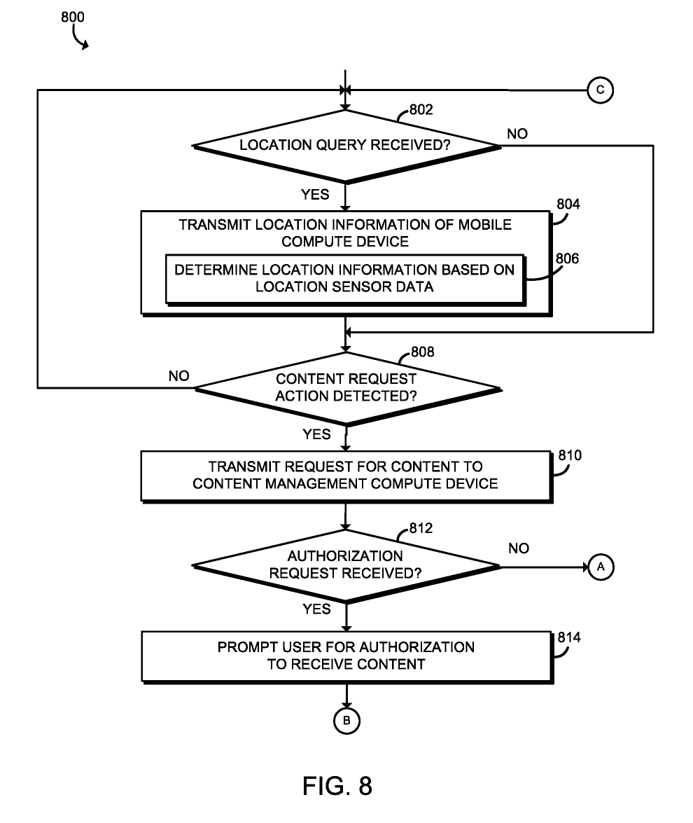

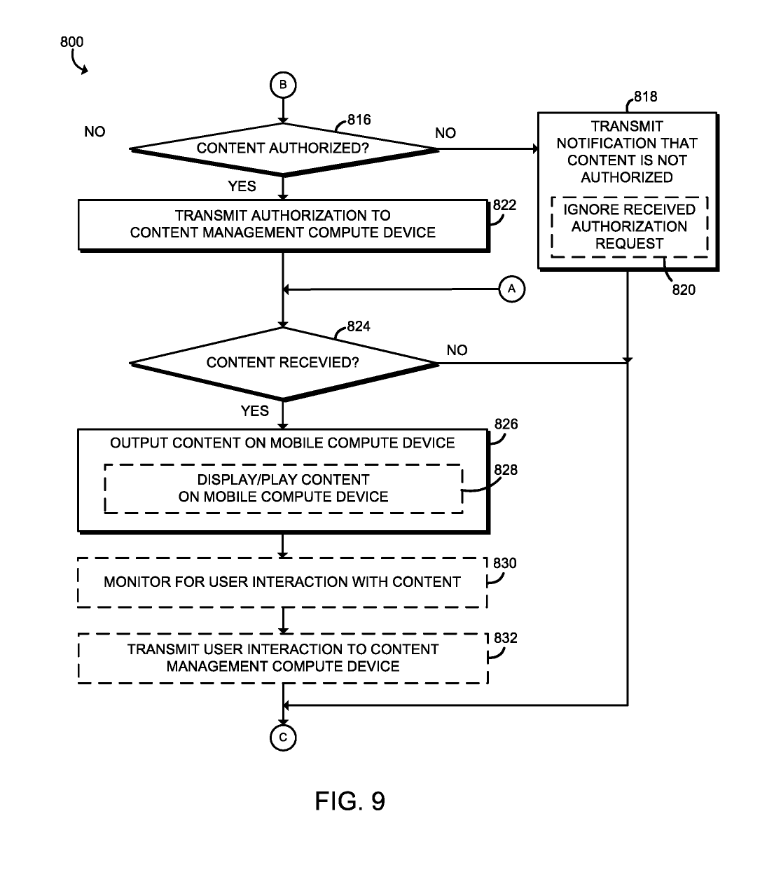

Referring now to FIGS. 8-9, in use, the mobile compute device 102 may execute a method 800 for receiving content related to a content object 106. The method 800 begins with block 802 in which the mobile compute device 102 determines whether a location query is received from the content management compute device 104. If not, the method 800 advances to block 808 discussed below. If, however, the mobile compute device 102 receives a location query, the method 800 advances to block 804 in which the mobile compute device 102 transmits location information indicative of the location of the mobile compute device 102 to the content management compute device 104. To do so, in some embodiments, the mobile compute device 102 may determine the location information based on location sensor data in block 806. In other embodiments, the mobile compute device 102 may transmit raw location sensor data to the content management compute device 104 in block 804. Regardless, after transmitting the location information to the content management compute device 104, the method 500 proceeds to block 808.

In block 808, the mobile compute device 102 determines whether a content request action is detected on the mobile compute device 102. For example, as described above, the user of the mobile compute device 102 may shake the mobile compute device 102 to request content. If the content request action is not detected, the method 800 loops back to block 802 in which the mobile compute device 102 continues to determine whether a location query has been received from the content management compute device 104. If, however, the mobile compute device 102 determines that a content request action has been detected, the method 800 advances to block 810. In block 810, the mobile compute device 102 transmits a request for the content of the content object 106 to content management compute device 104. As discussed above, the content request action may be embodied as a physical motion of the mobile compute device 102 in some embodiments. For example, the user may shake the mobile compute device 102 or move the device 102 in a particular pattern. In such embodiments, the mobile compute device 102 may transmit an indication that the content request action has been detected in block 810. Alternatively, in other embodiments, the mobile compute device 102 may transmit raw motion data (e.g., sensor data from one or more of the orientation sensors 122) in block 810. In yet other embodiments, the content request action may be a user interaction to a prompt to receive content. In such embodiments, the mobile compute device 102 may transmit an indication of the user's acceptance in block 810.

After the mobile compute device 102 has transmitted the request for content in block 810, the method 800 proceeds to block 812 in which the mobile compute device 102 determines whether an authorization request is received. As discussed above, in some embodiments, the content management compute device 104 may request an authorization from the mobile compute device 102 before transmitting the content. If the authorization request is not received, the method 500 advances to block 824 of FIG. 9 to determine whether the requested content has been received as discussed in detail below. If, however, an authorization request is received in block 812, the method 500 advances to block 814 in which the mobile compute device 102 prompts the user of the mobile compute device 102 for an authorization to receive the content. In block 816 of FIG. 9, the mobile compute device 102 determines whether the receipt of the content has been authorized by the user. If not, the method 800 advances to block 818 in which the mobile compute device 102 transmits a notification to the content management compute device 104 that receipt of content is not authorized. Alternatively, in some embodiments, the mobile compute device 102 may simply ignore the received authorization request from the content management compute device 104 in block 820. The method 800 subsequently loops back to block 802 of FIG. 8 in which the mobile compute device 102 continues to determine whether a location query is received from the content management compute device 104.

If, however, the mobile compute device 102 determines that the content is authorized in block 816, the method 800 advances to block 822 in which the mobile compute device 102 transmits the authorization to the content management compute device 104. In block 824, the mobile compute device 102 determines whether any content has been received. It should be appreciated that, in some embodiments, the method 800 may also advance to block 824 to determine whether any content is received even if the user of the mobile compute device 102 did not authorize the content in block 816. For example, the content management compute device 104 may be configured to transmit default content if the user has not authorized receipt of specialized content.

If the mobile compute device 102 determines, after some period of time, that no content has been received, the method 800 loops back to block 802 in which the mobile compute device 102 continues to determine whether a location query has been received from the content management compute device 104. If, however, the mobile compute device 102 determines that content related to the selected content object 106 has been received in block 824, the method 800 advances to block 826. In block 826, the mobile compute device 102 outputs the content on the mobile compute device 102. To do so, in some embodiments, the mobile compute device 102 may display, play, or otherwise present the content to the user in block 828. In some embodiments, the method 800 may further proceed to blocks 830, 832. In block 830, the mobile compute device 102 monitors for user interaction with the received content and transmits any detected user interaction to the content management compute device 104 in block 832. The method 800 subsequently loops back to block 802 to continue to determine whether a location query is received from the content management compute device 104.

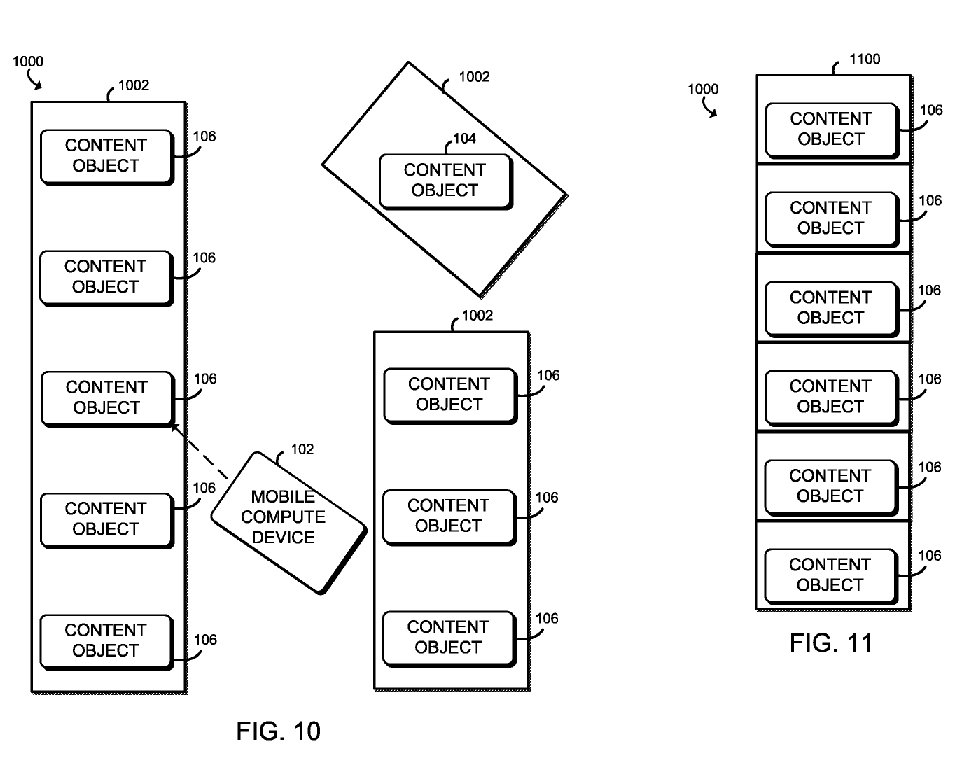

Referring now to FIGS. 10 and 11, an illustrative content object location mappings 1000 of the content object location mapping 420 is shown. The content object location mapping 1000 shown in FIG. 10 includes a multiple shelves 1002, with each shelf 1002 having multiple content objects 106 located thereon. The content object location mapping 1000 allows the content management compute device 104 to distinguish the content objects 106 closely arranged in a horizontal plane (xy-plane). To illustrate how the user of the mobile compute device 102 would select a desired content object 106, the mobile compute device 102 is shown in the content object location mapping 1000 with a pointing vector (shown in a dotted arrow) directed to a desired content object 106. As discussed above, the content management compute device 104 is configured to determine the desired content object 106 by determining a pointing vector of the mobile compute device 102 based on the location and orientation of the mobile compute device 102. Referring now to FIG. 11, the content object location mapping 1000 also includes a shelf 1100 having multiple content rows, with each row having a content object 106 located thereon. The content object location mapping 1000 allows the content management compute device 104 to distinguish the content objects 106 closely arranged along a vertical axis (z-axis). Of course, it should be appreciated that the content object location mapping 420 may be embodied as a three dimensional mapping in some embodiments. Such a three dimension mapping allows the content management compute device 104 to determine which content object 106 the pointing vector of the mobile compute device 102 in directed toward in three dimensions as discussed above.

### EXAMPLES

Illustrative examples of the technologies disclosed herein are provided below. An embodiment of the technologies may include any one or more, and any combination of, the examples described below.

Example 1 includes a content management compute device to deliver content to a mobile compute device, the content management compute device comprising a compute device location determiner to acquire a location of the mobile compute device and determine, based on the location of the mobile compute device, whether the mobile compute device is within a threshold range of one or more content objects; a content object selection analyzer to acquire an orientation of the mobile compute device and identify a content object of the one or more content objects that is presently selected by a user of the mobile compute device based on the location and orientation of the mobile compute device; a content manager to select content based on the identified content object; and a communicator to transmit the selected content to the mobile compute device.

Example 2 includes the subject matter of Example 1, and wherein to acquire the location of the mobile compute device comprises to receive, from the mobile compute device, location information indicative of a location of the mobile compute device; and determine a location of the mobile compute device relative to the one or more content objects based on the location information.

Example 3 includes the subject matter of any of Examples 1 and 2, and wherein to acquire the location of the mobile compute device comprises to receive communication signals from the mobile compute device; and determine a location of the mobile compute device relative to the one or more content objects based on the communication signals.

Example 4 includes the subject matter of any of Examples 1-3, and wherein to determine whether the compute device is within the threshold range of the one or more content objects comprises to compare the location of the mobile compute device to a content object location mapping of a location at which the one or more content objects are located.

Example 5 includes the subject matter of any of Examples 1-4, and wherein to acquire the orientation of the mobile compute device comprises to receive, from the mobile compute device, orientation information indicative of a present orientation of the mobile compute device, and to identify the content object comprises to determine a pointing vector of the mobile compute device based on the orientation information.

Example 6 includes the subject matter of any of Examples 1-5, and wherein to acquire the orientation of the mobile compute device comprises to receive, from the mobile compute device, orientation sensor data produced by one or more orientation sensors of the mobile compute device, and to identify the content object comprises to determine a pointing vector of the mobile compute device based on the orientation sensor data.

Example 7 includes the subject matter of any of Examples 1-6, and wherein to identify the content object comprises to determine a pointing vector of the mobile compute device based on the orientation of the mobile compute device.

Example 8 includes the subject matter of any of Examples 1-7, and wherein to identify the content object comprises to identify the content object of the one or more content objects based on the location and the pointing vector of the mobile compute device.

Example 9 includes the subject matter of any of Examples 1-8, and wherein to identify the content object comprises to compare the location and pointing vector of the mobile compute device to content object location mapping of a location at which the one or more content objects are located.

Example 10 includes the subject matter of any of Examples 1-9, and wherein the pointing vector comprises a longitudinal axis of the mobile compute device.

Example 11 includes the subject matter of any of Examples 1-10, and wherein to select the content comprises to determine whether content is available for the identified content object; and select default content in response to determination that no content is available for the identified content object.

Example 12 includes the subject matter of any of Examples 1-11, and wherein to select the default content comprises to select content based on the location of the mobile compute device.

Example 13 includes the subject matter of any of Examples 1-12, and wherein to select the default content comprises to select content based on a context of the mobile compute device.

Example 14 includes the subject matter of any of Examples 1-13, and, wherein to select the content comprises to retrieve the content from a content database of the content management compute device having stored therein multiple content.

Example 15 includes the subject matter of any of Examples 1-14, and wherein the content manager is further to monitor for a user interaction with the content transmitted to the mobile compute device.

Example 16 includes the subject matter of any of Examples 1-15, and wherein the communicator is further to transmit additional content to the mobile compute device in response to the user interaction.

Example 17 includes the subject matter of any of Examples 1-16, and wherein the content object selection analyzer is further to monitor for a content request action from the mobile compute device prior to the transmission of the selected content.

Example 18 includes the subject matter of any of Examples 1-17, and wherein the content request action comprises a predefined motion of the mobile compute device.

Example 19 includes the subject matter of any of Examples 1-18, and wherein the content request action comprises an indication, received from the mobile compute device, that the user of the mobile compute device desires to receive the content.

Example 20 includes the subject matter of any of Examples 1-19, and wherein the content manager is further to determine whether the mobile compute device is presently locked, wherein to select the content comprises to select default content in response to a determination that the mobile compute device is locked.

Example 21 includes the subject matter of any of Examples 1-20, and wherein to select the default content comprises to select content based on the location of the mobile compute device.

Example 22 includes the subject matter of any of Examples 1-21, and wherein the content manager is further to request, from the mobile compute device, authorization to transmit the selected content to the mobile compute device prior to transmitting the content, wherein to transmit the selected content comprises to transmit the selected content to the mobile compute device in response to receipt of the authorization from the mobile compute device.

Example 23 includes a method for delivery content to a mobile compute device, the method comprising acquiring, by a content management compute device, a location of the mobile compute device; determining, by the content management compute device, whether the mobile compute device is within a threshold range of one or more content objects based on the location of the mobile compute device; acquiring, by the content management compute device, an orientation of the mobile compute device; identifying, by the content management compute device, a content object of the one or more content objects that is presently selected by a user of the mobile compute device based on the location and orientation of the mobile compute device; selecting, by the content management compute device, content based on the identified content object; and transmitting, by the content management compute device, the selected content to the mobile compute device.

Example 24 includes the subject matter of Example 23, and wherein acquiring the location of the mobile compute device comprises receiving, from the mobile compute device, location information indicative of a location of the mobile compute device; and determining a location of the mobile compute device relative to the one or more content objects based on the location information.

Example 25 includes the subject matter of any of Examples 23 and 24, and wherein acquiring the location of the mobile compute device comprises receiving communication signals from the mobile compute device; and determining a location of the mobile compute device relative to the one or more content objects based on the communication signals.

Example 26 includes the subject matter of any of Examples 23-25, and wherein determining whether the compute device is within the threshold range of the one or more content objects comprises comparing the location of the mobile compute device to a content object location mapping of a location at which the one or more content objects are located.

Example 27 includes the subject matter of any of Examples 23-26, and wherein acquiring the orientation of the mobile compute device comprises receiving, from the mobile compute device, orientation information indicative of a present orientation of the mobile compute device, and identifying the content object comprises determining a pointing vector of the mobile compute device based on the orientation information.

Example 28 includes the subject matter of any of Examples 23-27, and wherein acquiring the orientation of the mobile compute device comprises receiving, from the mobile compute device, orientation sensor data produced by one or more orientation sensors of the mobile compute device, and identifying the content object comprises determining a pointing vector of the mobile compute device based on the orientation sensor data.

Example 29 includes the subject matter of any of Examples 23-28, and wherein identifying the content object comprises determining a pointing vector of the mobile compute device based on the orientation of the mobile compute device.

Example 30 includes the subject matter of any of Examples 23-29, and wherein identifying the content object comprises identifying the content object of the one or more content objects based on the location and the pointing vector of the mobile compute device.

Example 31 includes the subject matter of any of Examples 23-30, and wherein identifying the content object comprises comparing the location and pointing vector of the mobile compute device to content object location mapping of a location at which the one or more content objects are located.

Example 32 includes the subject matter of any of Examples 23-31, and wherein the pointing vector comprises a longitudinal axis of the mobile compute device.

Example 33 includes the subject matter of any of Examples 23-32, and wherein selecting the content comprises determining whether content is available for the identified content object; and selecting default content in response to determination that no content is available for the identified content object.

Example 34 includes the subject matter of any of Examples 23-33, and wherein selecting the default content comprises selecting content based on the location of the mobile compute device.

Example 35 includes the subject matter of any of Examples 23-34, and wherein selecting the default content comprises selecting content based on a context of the mobile compute device.

Example 36 includes the subject matter of any of Examples 23-35, and wherein selecting the content comprises retrieving the content from a content database of the content management compute device having stored therein multiple content.

Example 37 includes the subject matter of any of Examples 23-36, and further including monitoring, by the content management compute device, for a user interaction with the content transmitted to the mobile compute device.

Example 38 includes the subject matter of any of Examples 23-37, and further including transmitting, by the content management compute device, additional content to the mobile compute device in response to the user interaction.

Example 39 includes the subject matter of any of Examples 23-38, and further including monitoring, by the content management compute device, for a content request action from the mobile compute device prior to transmitting the selected content.

Example 40 includes the subject matter of any of Examples 23-39, and wherein the content request action comprises a predefined motion of the mobile compute device.

Example 41 includes the subject matter of any of Examples 23-40, and wherein the content request action comprises an indication, received from the mobile compute device, that the user of the mobile compute device desires to receive the content.

Example 42 includes the subject matter of any of Examples 23-41, and further including determining whether the mobile compute device is presently locked, wherein selecting the content comprises selecting default content in response to a determination that the mobile compute device is locked.

Example 43 includes the subject matter of any of Examples 23-42, and wherein selecting the default content comprises selecting content based on the location of the mobile compute device.

Example 44 includes the subject matter of any of Examples 23-43, and further including requesting, by the content management compute device and from the mobile compute device, authorization to transmit the selected content to the mobile compute device prior to transmitting the content, wherein transmitting the selected content comprises transmitting the selected content to the mobile compute device in response to receipt of the authorization from the mobile compute device.

Example 45 includes one or more machine-readable storage media comprising a plurality of instructions stored thereon that, when executed, causes sensor controller of a content management compute device to perform the method of any of Examples 23-44.

Example 46 includes a content management compute device comprising means for acquiring a location of the mobile compute device; means for determining whether the mobile compute device is within a threshold range of one or more content objects based on the location of the mobile compute device; means for acquiring an orientation of the mobile compute device; means for identifying a content object of the one or more content objects that is presently selected by a user of the mobile compute device based on the location and orientation of the mobile compute device; means for selecting content based on the identified content object; and means for transmitting the selected content to the mobile compute device.

Example 47 includes the subject matter of Example 46, and wherein the means for acquiring the location of the mobile compute device comprises means for receiving, from the mobile compute device, location information indicative of a location of the mobile compute device; and means for determining a location of the mobile compute device relative to the one or more content objects based on the location information.

Example 48 includes the subject matter of any of Examples 46 and 47, and wherein the means for acquiring the location of the mobile compute device comprises means for receiving communication signals from the mobile compute device; and means for determining a location of the mobile compute device relative to the one or more content objects based on the communication signals.

Example 49 includes the subject matter of any of Examples 46-48, and wherein the means for determining whether the compute device is within the threshold range of the one or more content objects comprises means for comparing the location of the mobile compute device to a content object location mapping of a location at which the one or more content objects are located.

Example 50 includes the subject matter of any of Examples 46-49, and wherein the means for acquiring the orientation of the mobile compute device means for comprises receiving, from the mobile compute device, orientation information indicative of a present orientation of the mobile compute device, and the means for identifying the content object comprises means for determining a pointing vector of the mobile compute device based on the orientation information.

Example 51 includes the subject matter of any of Examples 46-50, and wherein the means for acquiring the orientation of the mobile compute device comprises means for receiving, from the mobile compute device, orientation sensor data produced by one or more orientation sensors of the mobile compute device, and the means for identifying the content object comprises means for determining a pointing vector of the mobile compute device based on the orientation sensor data.

Example 52 includes the subject matter of any of Examples 46-51, and wherein the means for identifying the content object comprises means for determining a pointing vector of the mobile compute device based on the orientation of the mobile compute device.

Example 53 includes the subject matter of any of Examples 46-52, and wherein the means for identifying the content object comprises means for identifying the content object of the one or more content objects based on the location and the pointing vector of the mobile compute device.

Example 54 includes the subject matter of any of Examples 46-53, and wherein the means for identifying the content object comprises means for comparing the location and pointing vector of the mobile compute device to content object location mapping of a location at which the one or more content objects are located.

Example 55 includes the subject matter of any of Examples 46-54, and wherein the pointing vector comprises a longitudinal axis of the mobile compute device.

Example 56 includes the subject matter of any of Examples 46-55, and wherein the means for selecting the content comprises means for determining whether content is available for the identified content object; and means for selecting default content in response to determination that no content is available for the identified content object.

Example 57 includes the subject matter of any of Examples 46-56, and wherein the means for selecting the default content comprises means for selecting content based on the location of the mobile compute device.

Example 58 includes the subject matter of any of Examples 46-57, and wherein the means for selecting the default content comprises means for selecting content based on a context of the mobile compute device.

Example 59 includes the subject matter of any of Examples 46-58, and wherein the means for selecting the content comprises means for retrieving the content from a content database of the content management compute device having stored therein multiple content.

Example 60 includes the subject matter of any of Examples 46-59, and, further including means for monitoring for a user interaction with the content transmitted to the mobile compute device.

Example 61 includes the subject matter of any of Examples 46-60, and further including means for transmitting additional content to the mobile compute device in response to the user interaction.

Example 62 includes the subject matter of any of Examples 46-61, and further including means for monitoring for a content request action from the mobile compute device prior to transmitting the selected content.

Example 63 includes the subject matter of any of Examples 46-62, and wherein the content request action comprises a predefined motion of the mobile compute device.

Example 64 includes the subject matter of any of Examples 46-63, and wherein the content request action comprises an indication, received from the mobile compute device, that the user of the mobile compute device desires to receive the content.

Example 65 includes the subject matter of any of Examples 46-64, and further including means for determining whether the mobile compute device is presently locked, wherein the means for selecting the content comprises means for selecting default content in response to a determination that the mobile compute device is locked.

Example 66 includes the subject matter of any of Examples 46-65, and wherein the means for selecting the default content comprises means for selecting content based on the location of the mobile compute device.

Example 67 includes the subject matter of any of Examples 46-66, and further including means for requesting, from the mobile compute device, authorization to transmit the selected content to the mobile compute device prior to transmitting the content, wherein means for transmitting the selected content comprises means for transmitting the selected content to the mobile compute device in response to receipt of the authorization from the mobile compute device.

1. A content management compute device to deliver content to a mobile compute device, the content management compute device comprising:
a compute device location determiner to acquire a location of the mobile compute device and determine, based on the location of the mobile compute device, whether the mobile compute device is within a threshold range of one or more content objects;
a content object selection analyzer to acquire an orientation of the mobile compute device and identify a content object of the one or more content objects that is presently selected by a user of the mobile compute device based on the location and orientation of the mobile compute device;
a content manager to select content based on the identified content object; and
a communicator to transmit the selected content to the mobile compute device.

2. The content management compute device of claim 1, wherein to identify the content object comprises to determine a pointing vector of the mobile compute device based on the orientation of the mobile compute device.

3. The content management compute device of claim 2, wherein to identify the content object comprises to identify the content object of the one or more content objects based on the location and the pointing vector of the mobile compute device.

4. The content management compute device of claim 2, wherein to identify the content object comprises to compare the location and pointing vector of the mobile compute device to content object location mapping of a location at which the one or more content objects are located.

5. The content management compute device of claim 1, wherein the pointing vector comprises a longitudinal axis of the mobile compute device.

6. The content management compute device of claim 1, wherein the content object selection analyzer is further to monitor for a content request action from the mobile compute device prior to the transmission of the selected content.

7. The content management compute device of claim 6, wherein the content request action comprises a predefined motion of the mobile compute device.

8. The content management compute device of claim 6, wherein the content request action comprises an indication, received from the mobile compute device, that the user of the mobile compute device desires to receive the content.

9. The content management compute device of claim 1, wherein the content manager is further to determine whether the mobile compute device is presently locked, wherein to select the content comprises to select default content in response to a determination that the mobile compute device is locked.

10. A method for delivery content to a mobile compute device, the method comprising:
acquiring, by a content management compute device, a location of the mobile compute device;
determining, by the content management compute device, whether the mobile compute device is within a threshold range of one or more content objects based on the location of the mobile compute device;
acquiring, by the content management compute device, an orientation of the mobile compute device;
identifying, by the content management compute device, a content object of the one or more content objects that is presently selected by a user of the mobile compute device based on the location and orientation of the mobile compute device;
selecting, by the content management compute device, content based on the identified content object; and
transmitting, by the content management compute device, the selected content to the mobile compute device.

11. The method of claim 10, wherein identifying the content object comprises determining a pointing vector of the mobile compute device based on the orientation of the mobile compute device.

12. The method of claim 11, wherein identifying the content object comprises identifying the content object of the one or more content objects based on the location and the pointing vector of the mobile compute device.

13. The method of claim 11, wherein identifying the content object comprises comparing the location and pointing vector of the mobile compute device to content object location mapping of a location at which the one or more content objects are located.

14. The method of claim 10, wherein the pointing vector comprises a longitudinal axis of the mobile compute device.

15. The method of claim 10, further comprising monitoring, by the content management compute device, for a content request action from the mobile compute device prior to transmitting the selected content.

16. The method of claim 15, wherein the content request action comprises a predefined motion of the mobile compute device.

17. The method of claim 15, wherein the content request action comprises an indication, received from the mobile compute device, that the user of the mobile compute device desires to receive the content.

18. One or more machine-readable storage media comprising a plurality of instructions stored thereon that, when executed, causes a content management compute device to:
acquire a location of a mobile compute device;
determine whether the mobile compute device is within a threshold range of one or more content objects based on the location of the mobile compute device;
acquire an orientation of the mobile compute device;
identify a content object of the one or more content objects that is presently selected by a user of the mobile compute device based on the location and orientation of the mobile compute device;
select content based on the identified content object; and
transmit the selected content to the mobile compute device.

19. The one or more machine-readable storage media of claim 18, wherein to identify the content object comprises to determine a pointing vector of the mobile compute device based on the orientation of the mobile compute device.

20. The one or more machine-readable storage media of claim 11, wherein to identify the content object comprises to identify the content object of the one or more content objects based on the location and the pointing vector of the mobile compute device.

21. The one or more machine-readable storage media of claim 11, wherein to identify the content object comprises to compare the location and pointing vector of the mobile compute device to content object location mapping of a location at which the one or more content objects are located.

22. The one or more machine-readable storage media of claim 18, wherein the pointing vector comprises a longitudinal axis of the mobile compute device.

23. The one or more machine-readable storage media of claim 18, wherein the plurality of instructions, when executed, further causes the content management compute device to monitor for a content request action from the mobile compute device prior to transmitting the selected content.

24. The one or more machine-readable storage media of claim 23, wherein the content request action comprises a predefined motion of the mobile compute device.

25. The one or more machine-readable storage media of claim 23, wherein the content request action comprises an indication, received from the mobile compute device, that the user of the mobile compute device desires to receive the content.
